(19) United States
(12) Patent Application Publication
(10) Pub. No.: US 2026/0094416 A1
(43) Pub. Date: Apr. 2, 2026

(54) DATA PROCESSING METHOD AND APPARATUS

(71) Applicant: Lenovo (Beijing) Limited, Beijing (CN)

(72) Inventors: Yuanhui LI, Beijing (CN); Qigang WANG, Beijing (CN); Peng WANG, Beijing (CN)

(21) Appl. No.: 19/333,189

(22) Filed: Sep. 18, 2025

(30) Foreign Application Priority Data
Sep. 29, 2024 (CN) 202411377644.2

(51) Int. Cl. G06V 10/77; G06T 1/20

(52) U.S. Cl. CPC G06V 10/7715; G06T 1/20

(57) ABSTRACT

A data processing method including generating, by a first processor, an initial feature vector in response to a target reasoning task. The initial feature vector includes first and second feature bits corresponding to first and second data, respectively, in the target reasoning task. The and the second data are of different types. The method further includes determining, by a second processor, one or more first data features corresponding to the first data and one or more second data features corresponding to the second data, updating, by the second processor, the first feature bits and the second feature bits using the one or more first data features and the one or more second data features, respectively, to obtain a target feature vector, and performing model reasoning based on the target feature vector to obtain a target reasoning result corresponding to the target reasoning task.

### CROSS-REFERENCE TO RELATED APPLICATION

This application claims priority to Chinese Patent Application No. 202411377644.2, filed on Sep. 29, 2024, the entire content of which is incorporated herein by reference.

### TECHNICAL FIELD

The present disclosure generally relates to the field of computer technologies and, more particularly, to a data processing method and a data processing apparatus.

### BACKGROUND

With the development of artificial intelligence (AI) technology, AI models used to implement various AI functions are increasingly appearing in people's daily lives and work.

During a model reasoning process, especially in a distributed system, model reasoning may require transmission of a large amount of data between different hardware, resulting in a slow reasoning speed for the entire system. For application scenarios that require real-time or near real-time response, such as dialogue systems or recommendation systems, reasoning delays will bring poor user experience.

### SUMMARY

In accordance with the disclosure, there is provided a data processing method including generating, by a first processor, an initial feature vector in response to a target reasoning task. The initial feature vector includes a plurality of first feature bits and a plurality of second feature bits corresponding to first data and second data, respectively, in the target reasoning task, and the first data and the second data are of different types. The method further includes determining, by a second processor, one or more first data features corresponding to the first data and one or more second data features corresponding to the second data, updating, by the second processor, the plurality of first feature bits and the plurality of second feature bits using the one or more first data features and the one or more second data features, respectively, to obtain a target feature vector, and performing model reasoning based on the target feature vector to obtain a target reasoning result corresponding to the target reasoning task.

Also in accordance with the disclosure, there is provided an electronic device including a first processor and a second processor. The first processor is configured to generate an initial feature vector in response to a target reasoning task. The initial feature vector includes a plurality of first feature bits and a plurality of second feature bits corresponding to first data and second data, respectively, in the target reasoning task, and the first data and the second data are of different types. The second processor is configured to determine one or more first data features corresponding to the first data and one or more second data features corresponding to the second data, update the plurality of first feature bits and the plurality of second feature bits using the one or more first data features and the one or more second data features, respectively, to obtain a target feature vector, and perform model reasoning based on the target feature vector to obtain a target reasoning result corresponding to the target reasoning task.

Also in accordance with the disclosure, there is provided one or more non-transitory computer-readable storage mediums storing first instructions and second instructions. The first instructions, when executed by a first processor, cause the first processor to generate an initial feature vector in response to a target reasoning task. The initial feature vector includes a plurality of first feature bits and a plurality of second feature bits corresponding to first data and second data, respectively, in the target reasoning task, and the first data and the second data are of different types. The second instructions, when executed by a second processor, cause the second processor to determine one or more first data features corresponding to the first data and one or more second data features corresponding to the second data, update the plurality of first feature bits and the plurality of second feature bits using the one or more first data features and the one or more second data features, respectively, to obtain a target feature vector, and perform model reasoning based on the target feature vector to obtain a target reasoning result corresponding to the target reasoning task.

### BRIEF DESCRIPTION OF THE DRAWINGS

To more clearly illustrate the technical solutions of the embodiments of the present disclosure, the drawings needed for use in the description of the embodiments will be briefly introduced below. The drawings described below are some embodiments of the present disclosure. For those of ordinary skill in the art, other drawings can be obtained according to these drawings without any creative work.

FIG. 1 is a flow chart of a data processing method consistent with embodiments of the present disclosure FIG. 2 is a flow chart of another data processing method consistent with embodiments of the present disclosure.

FIG. 3 is a timing diagram when GPUs are used to perform parallel processing in the example shown in FIG. 2.

FIG. 4 is a schematic structural diagram of a data processing apparatus consistent with embodiments of the present disclosure.

FIG. 5 is a schematic hardware diagram of an electronic device consistent with embodiments of the present disclosure.

### DETAILED DESCRIPTION OF THE EMBODIMENTS

Various schemes and features of the present disclosure are described herein with reference to the accompanying drawings. It should be understood that various modifications may be made to the embodiments of the present disclosure. Therefore, the description should not be regarded as limiting, but only as examples of the embodiments. Based on the embodiments in the present disclosure, all other embodiments obtained by those skilled in the art without creative work are within the scope of the present disclosure.

In the following description, this specification may use the phrases “in one embodiment,” “in another embodiment,” or “in some embodiments,” which may describe a subset of all possible embodiments, but it is understood that “some embodiments” can be the same subset or different subsets of all possible embodiments, and can be combined with each other without conflict.

The terms “first/second/third” are only used to distinguish similar objects, and do not represent a specific order for the objects. It is understood that objects described in connection with “first/second/third” can be in any order or sequence where permitted, such that the embodiments of the present disclosure described here can be implemented in an order other than that illustrated or described here.

Unless otherwise defined, all technical and scientific terms used in the present disclosure have the same meaning as those generally understood by those skilled in the art. The terms used in the present disclosure are only for the purpose of description and are not intended to limit the scope of the present disclosure.

Some model reasoning frameworks do not support multimodal data processing on a graphics processing unit (GPU). Therefore, the models need to be deployed on a central processing unit (CPU) and the GPU at the same time. When performing a model reasoning task, the model reasoning process can be briefly described as follows. First, the CPU is used to extract data features of multimodal data. Then, padding processing is performed on the extracted data features. Subsequently, the data features after padding processing are sent to the GPU for subsequent model reasoning. Finally, the GPU sends model reasoning results to the CPU, such that the CPU generates and outputs task processing results that are finally given to a user.

The CPU needs to send the data features of the multimodal data to the GPU, which results in a large amount of data interaction between the CPU and the GPU, slowing down the reasoning speed of the entire system.

Also, the model is deployed on the CPU and GPU at the same time, and the CPU and GPU are heterogeneous processing units. Therefore, later quantization operation of the model needs to be performed on the CPU and GPU, separately, and the compatibility issues between the CPU and the GPU needs to be considered, resulting in a high cost of the quantization operation. Performing the later quantization operation on the model can reduce the memory usage of the model, increase the calculation speed, reduce the hardware power consumption, and reduce the deployment and reasoning costs.

The present disclosure provides a data processing method to at least partially alleviate the above problems. The data processing method may be executed by a processor of a computer apparatus. The computer apparatus may be an apparatus with data processing capabilities, such as a server, a laptop, a tablet computer, a desktop computer, a mobile device, etc.

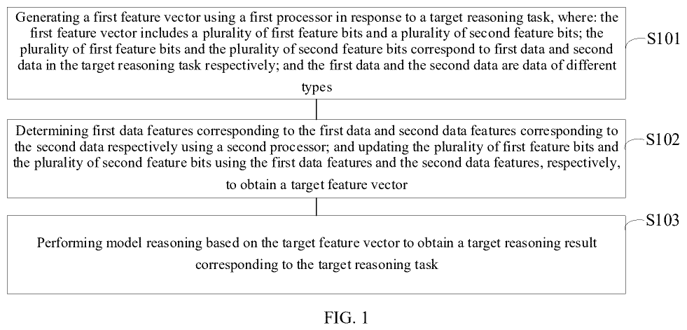

In one embodiment shown in FIG. 1, which is a flow chart of a data processing method consistent with the present disclosure, the data processing method includes S101 to S103.

At S101, in response to a target reasoning task, a first processor is used to generate a first feature vector (also referred to as an “initial feature vector”). The first feature vector includes a plurality of first feature bits and a plurality of second feature bits. The plurality of first feature bits and the plurality of second feature bits correspond to first data and second data in the target reasoning task, respectively. The first data and the second data are data of different types.

The target reasoning task may be a model reasoning task that needs to be performed using an AI model.

In some embodiments, the target reasoning task may be determined based on an AI task input by a user or may be determined based on information detection of other applications.

In some embodiments, the target reasoning task may be a text-to-text generation task, a multimodal information-to-text generation task (for example, a task of generating a picture using text and a picture), a text-to-picture generation task, a picture-to-picture generation task, and the like.

In some embodiments, the AI model used to perform the target reasoning task may be a large language model, a multimodal model, a diffusion model, and the like.

The target reasoning task may include the first data and the second data, and the data types of the first data and the second data may be different, that is, the target reasoning task may include data of a plurality of modalities.

In some embodiments, the first data and the second data may be text-type data, image-type data, and/or audio-type data, and the data types of the first data and the second data may be different. For example, the first data may be text-type data, and the second data may be image-type data or audio-type data.

The first processor may be a processor with data processing capability in an electronic device.

In some embodiments, the first processor may be a processor with data processing, task scheduling, management, and control functions in the electronic device.

In some embodiments, the first processor may be a CPU, a microprocessor unit (MPU), a digital signal processor (DSP), or a field programmable gate array (FPGA), etc.

The first feature vector may be a feature vector generated based on the first data and the second data in the target reasoning task, and may be used to store data features corresponding to the first data and the second data. The plurality of first feature bits in the first feature vector may be used to store the data features corresponding to the first data, and the plurality of second feature bits in the first feature vector may be used to store the data features corresponding to the second data.

In some embodiments, generating the first feature vector using the first processor may include generating the first feature vector using the first processor based on the data types of the first data and the second data; or may include generating the first feature vector using the first processor based on the data amounts of the first data and the second data.

At S102, a second processor is used to determine first data features corresponding to the first data and second data features corresponding to the second data, and the plurality of first feature bits and the plurality of second feature bits are updated using the first data features and the second data features respectively to obtain a target feature vector.

The second processor may be a processor used to perform model reasoning in an electronic device.

In some embodiments, the second processor may be a processor that supports spatial parallel computing.

In some embodiments, the second processor may be a GPU, a neural network processor (NPU), a deep learning processor (DPU), or another processor commonly used and supporting parallel computing.

In one embodiment, using the second processor, feature extraction may be performed on the first data and the second data respectively to obtain the first data features of the first data and the second data features of the second data.

In some embodiments, using the second processor, the feature extraction on the first data and the second data may be performed in parallel.

The first data features may be used to update the plurality of first feature bits in the first feature vector, and the second data features may be used to update the plurality of second feature bits in the first feature vector, to obtain the target feature vector including the data features of two types of data. That is, the first data features and the second data features may be fused into the first feature vector to obtain the target feature vector.

At S103, model reasoning is performed based on the target feature vector to obtain a target reasoning result corresponding to the target reasoning task.

The target reasoning result may be a task processing result output to the user. For example, when the target reasoning task is a picture-to-picture task, the target reasoning result may be a picture result generated by the model.

The multi-layer neural network of the model deployed on the second processor may be used to perform model reasoning based on the fused target feature vector to obtain the target reasoning result corresponding to the target reasoning task.

In the data processing method provided by the present disclosure, the first feature vector corresponding to the first data and the second data in the target reasoning task may be generated on the first processor. Then, the first data features of the first data and the second data features of the second data may be fused on the second processor based on the first feature vector to obtain the target feature vector, and data reasoning may be completed based on the target feature vector. Therefore, in the present embodiment, the first feature vector may be generated through the first processor and may be sent to the second processor, such that the second processor may fuse the data features of the two types of data based on the first feature vector to obtain the target feature vector. Compared with the existing technologies that use the first processor to perform feature extraction on the two types of data and transmit the extracted features to the second processor for subsequent model reasoning, the amount of data transmission between the first processor and the second processor may be reduced, thereby improving the overall reasoning speed of the system. Also, compared with the existing technologies that require subsequent quantization operations on the CPU and GPU at the same time, in the present disclosure, the feature extraction of the first data and the second data and the subsequent model reasoning tasks may be performed on the second processor end, and the first processor and the second processor may collaborate in parallel, further improving the reasoning speed. And, in the later stage, quantization operations do not need to be performed on the second processor, reducing the cost of the later quantization operations.

In some embodiments, using the second processor to determine the first data features corresponding to the first data and the second data features corresponding to the second data (S102) may include:

S1021, using the second processor to perform a first processing and a second processing in parallel.

The first processing may include receiving the first feature vector and the first data from the first processor, and determining the first data features corresponding to the first data.

The second processing may include reading the second data from a target memory, and determining the second data features corresponding to the second data.

Therefore, on the second processor, the feature extraction task of the first data and the feature extraction task of the second data may be performed in parallel.

In some embodiments, the first data features and the second data features may both be token-level data.

In some embodiments, in response to the target reasoning task, the second processor may determine the target memory for storing the second data, and obtain the second data from the target memory.

In some embodiments, the target memory may be a memory or a cache corresponding to the first processor.

In some embodiments, the target memory may be a memory in the electronic device other than the memory or cache corresponding to the first processor.

In some embodiments, when the second processor performs the feature extraction on the first data and the second data, the second processor may perform slicing processing on the first data and the second data respectively to obtain a plurality of data slices, and perform the feature extraction based on the plurality of data slices. Therefore, when the second processor is a processor that supports parallel processing, the feature extraction speed of the first data and the second data may be improved by performing slicing processing on the first data and the second data. Also, performing slicing processing on the first data and the second data may cover the time for the second processor to obtain the first data and the second data from the first processor and the target memory, making data processing and scheduling more efficient.

In the above embodiment, the first processing and the second processing may be performed in parallel by the second processor. Therefore, the first processor may be used to generate the first feature vector, and the first feature vector and the first data may be sent to the second processor while or before the second processor reads the second data. Therefore, the first processor and the second processor may work in parallel, improving the overall data processing speed of the system. Also, the second processor may be used to determine the first data features of the first data and the second data features of the second data in parallel, which may further improve the overall data processing speed. Further, when the target storage area is a memory other than the memory or cache corresponding to the first processor in the electronic device, the action of the second processor reading the second data may not need to occupy the computing resources of the first processing, which may further improve the overall data processing speed of the system.

In some embodiments, using the first processor to generate the first feature vector in response to the target reasoning task (S101) may include S1011 to S1012.

At S1011, a first data length corresponding to the first data and a second data length corresponding to the second data may be determined.

The first data length may be a size of a storage space occupied by the first data feature of the first data, and the second data length may be a size of a storage space occupied by the second data feature of the second data.

In some embodiments, the first processor may determine the first data length and the second data length respectively based on the data types of the first data and the second data. For example, when the first data is text data and the second data is image data, the first data length may be configured as N bits and the second data length may be configured as M bits, where N and M are both integers larger than 1.

In some embodiments, the first data length may be determined based on the data volume of the first data.

The first processor may perform feature extraction on the first data to determine the data volume of the first data, and then the first data length may be determined based on the data volume.

For example, when the first data is text data, since the data volume corresponding to the text data is small, the computing resources and time occupied by performing feature extraction on it may be small. Therefore, the first processor may be used to perform feature extraction on the first data in advance to determine the first data length. For example, the first processor may use a tokenizer to convert the text data into token data that is able to be understood by the model, such that the first data length is determined based on the token data corresponding to the text data.

In some embodiments, the second data length may be determined based on the type information of the second data.

A corresponding fixed data length may be determined for different types of second data.

For example, when the second data is picture-type data, the second data length may be determined to be M bits. When the second data is audio-type data, the second data length may be determined to be R bits. M and R may both be integers larger than 1.

At S1012, based on the first data length and the second data length, the first feature vector may be generated such that the data lengths of the plurality of first feature bits and the data lengths of the plurality of second feature bits in the first feature vector correspond to the first data length and the second data length, respectively.

After determining the first data length and the second data length corresponding to the first data and the second data respectively, the first feature vector may be generated based on the first data length and the second data length. The data length of the first feature vector may be larger than the sum of the first data length and the second data length.

The data length of the plurality of first feature bits in the first feature vector may correspond to the first data length, such that the first data feature of the first data may be filled to the plurality of first feature bits. The data lengths of the plurality of second feature bits may correspond to the second data length, such that the second data features of the second data may be filled to the plurality of second feature bits.

In some embodiments, the data processing method may further include:

S104, using the first processor to traverse the first feature vector to generate an index vector of the first feature vector.

The index vector may include a plurality of first index bits and a plurality of second index bits, where the plurality of first index bits have a mapping relationship with the plurality of first feature bits and the plurality of second index bits have a mapping relationship with the plurality of second feature bits.

After the first processor generates the first feature vector, it may generate the corresponding index vector for the first feature vector. Therefore, when the first data feature and the second data feature are used to update the first feature vector, the plurality of first feature bits and the plurality of second feature bits in the first feature vector may be quickly located based on the index vector, thereby improving the update speed of the first feature vector.

In some embodiments, generating the index vector by the first processor may include: traversing the first feature vector in a preset order to identify each first feature bit and each second feature bit in the first feature vector; generating one corresponding first index bit for each first feature bit and one corresponding second index bit for each second feature bit; and arranging generated first index bits and second index bits according to the arrangement order of the plurality of first feature bits and the plurality of second feature bits in the first feature vector to obtain the index vector.

In some embodiments, the first feature vector may be a token-level vector, and accordingly, the index vector may also be a token-level vector.

In some embodiments, when the first processor is used to generate the first feature vector, the method may further include:

S1013: filling each of the plurality of second feature bits with a placeholder.

When the first processor generates the first feature vector, the plurality of second feature bits in the first feature vector may be filled with placeholders such that the plurality of second feature bits may be distinguished from the plurality of first feature bits.

In some embodiments, each second feature bit may be filled with a specified placeholder, and each first feature bit may not be filled.

Correspondingly, using the first processor to traverse the first feature vector to generate the index vector of the first feature vector (S104) may include S1041 and S1042.

At S1041, the first feature vector may be transversed to determine one corresponding first index bit for each feature bit in the first feature vector that does not contain the placeholder and determine a corresponding second index bit for each feature bit in the first feature vector that contains the placeholder.

In the process of the first processor traversing the first feature vector, based on whether each feature bit in the first feature vector is filled with a placeholder, whether the feature bit is the first feature bit or the second feature bit may be determined, thereby generating the corresponding first index bit or the corresponding second index bit.

In some embodiments, a mapping relationship between each index bit in the index vector and each feature bit in the first feature vector may be established. For example, identification information may be generated for each index bit in the index vector, to locate the corresponding feature bit in the first feature vector using the identification information.

In some embodiments, the first index bit and the second index bit may be filled with specified numbers or characters to distinguish the first index bit and the second index bit.

For example, each first index bit may be filled with a number “0,” and each second index bit may be filled with a number “1.”

S1042, based on the first index bits and the second index bits, the index vector may be generated.

The first processor may sort the generated plurality of first index bits and a plurality of second index bits according to the arrangement order of the plurality of first feature bits and the plurality of second feature bits in the first feature vector to obtain the index vector.

In the above embodiment, by filling a placeholder in each second feature bit, the first processor may quickly distinguish the first feature bits from the second feature bits and generate the corresponding first index bits and second index bits, thereby improving the generation speed of the index vector.

In some embodiments, the first processing in S1021 may further include receiving the index vector from the first processor. That is, the second processor may simultaneously receive the first data, the first feature vector and its corresponding index vector from the first processor.

Therefore, updating the first data features and the second data features using the plurality of first feature bits and the plurality of second feature bits, respectively, to obtain the target feature vector in S102 may include S1022 to S1023.

At S1022, based on the plurality of first index bits and the plurality of second index bits in the index vector, the plurality of first feature bits and the plurality of second feature bits in the first feature vector may be respectively determined.

Based on the index vector of the first feature vector, the plurality of first feature bits and the plurality of second feature bits in the first feature vector may be quickly located.

In some embodiments, one corresponding feature bit may be determined based on the identification information stored in each index bit.

At S1023, the plurality of first feature bits and the plurality of second feature bits may be updated using the first data features and the second data features, respectively, to obtain the target feature vector.

When the first feature bits are not filled with any information, the first data feature may be filled into the plurality of first feature bits, thereby realizing the update of the plurality of first feature bits.

The second data feature may be used to replace the placeholders in the plurality of second feature bits, thereby realizing the update of the plurality of second feature bits.

Therefore, the plurality of first feature bits may be updated using the first data feature, and the plurality of second feature bits may be updated using the second data feature, to obtain the target feature vector that integrates the features of different types of data in the target reasoning task.

In some embodiments, the execution order of S1022 and S1023 may not be fixed, that is, the steps of determining and updating the plurality of first feature bits and the plurality of second feature bits may be implemented as follows: determining the plurality of first feature bits based on the plurality of first index bits in the index vector; updating the plurality of first feature bits using the first data feature of the first data to obtain a second feature vector (also referred to as a “first intermediate feature vector”); determining the plurality of second feature bits based on the plurality of second index bits in the index vector; and updating the plurality of second feature bits in the second feature vector using the second data feature of the second data to obtain a target feature vector.

In the above embodiment, the plurality of first feature bits and the plurality of second feature bits in the first feature vector may be quickly and accurately located through the index vector. In particular, when the index vector is a token-level vector, each feature bit in the token-level first feature vector may be accurately located, avoiding the search time overhead caused by traversing the first feature vector using the second processor and improving the fusion speed of the first data feature and the second data feature. Also, there may be no filling information in the plurality of first feature bits in the first feature vector. Therefore, when fusing the first data feature and the second data feature, only the second data feature may be used to replace the placeholders in the plurality of second feature bits, further improving the fusion efficiency of the first data feature and the second data feature.

In some embodiments, updating the plurality of first feature bits and the plurality of second feature bits using the first data feature and the second data feature, respectively, to obtain the target feature vector in S102 may include:.

S1024, updating the plurality of first feature bits and the plurality of second feature bits using the first data feature and the second data feature, respectively, to obtain a third feature vector (also referred to as a “second intermediate feature vector”); and S1025, performing padding processing on the third feature vector to obtain the target feature vector.

On the second processor, the first data feature may be used to update the plurality of first feature bits in the first feature vector, and the second data feature may be used to update the plurality of second feature bits in the first feature vector to obtain the third feature vector. And, on the second processor, the updated third feature vector may be padded to obtain the target feature vector.

In related art, a first processor is used to perform feature extraction on first data and second data, fill processing is performed on the extracted data features, and the filled data features are transmitted to a second processor to continue to perform model reasoning. The filling operation will occupy the computing resources of the first processor, and the filled data will be transmitted to the second processor, further increasing the amount of data transmission between the first processor and the second processor. In the present disclosure, on the basis of using the second processor to perform feature extraction and fusion processing on the first data and the second data, the second processor may be further used to perform filling processing on the fused feature vector (i.e., the third feature vector), which may save the computing resources of the first processor and reduce the amount of data transmission and transmission time between the first processor and the second processor, thereby further improving the overall data processing speed of the system.

In some embodiments, the second processor may include a plurality of processor units.

The second processor may include the plurality of processor units, each of which may independently complete computing tasks. Therefore, the second processor may realize the parallel execution of a plurality of computing tasks.

Correspondingly, performing model reasoning based on the target feature vector to obtain a target reasoning result corresponding to the target reasoning task (S103) may include S1031 to S1032.

At S1031, based on a specified vector division rule, the target feature vector is divided into at least one target feature sub-vector.

The specified vector division rule may be a preset rule for slicing the target feature vector.

In some embodiments, the specified vector division rule may include dividing the target feature vector into at least one target feature sub-vector with equal data volume according to the unit data volume. For example, the target feature vector may be divided into a plurality of target feature sub-vectors with a data volume of 4 bits.

In some embodiments, the specified vector division rule may be determined according to the configuration information of the plurality of processor units in the second processor. For example, when the number of the plurality of processor units in the second processor is large, the target feature vector may be divided into a plurality of target feature sub-vectors with smaller unit data volume and larger total number. The target feature vector may be divided into a plurality of target feature sub-vectors with larger unit data volume and smaller total number when the number of the plurality of processor units in the second processor is small.

At S1032, the plurality of processing units are used to process the at least one target feature sub-vector in parallel to obtain the target reasoning result.

After dividing the target feature vector into the at least one target feature sub-vector, the at least one target sub-vector is assigned to the plurality of processing units of the second processor, and the at least one target sub-vector is executed in parallel by the plurality of processing units.

In the above embodiment, by dividing the target feature vector into at least one target feature sub-vector and using the plurality of processing units of the second processor for parallel processing, the plurality of parallel computing units of the second processor may be effectively utilized to improve the processing speed of the target reasoning task.

In some embodiments, the plurality of processing units in the second processor may process the at least one target sub-vector based on a continuous batching mechanism. That is, for each processing unit of the second processor, when receiving and preparing to start processing a first part of the data, if a part of a second part of the data is received, the processing unit may continue to process the first part of the data, and start to process the second part of the data after the first part of the data is processed and the second part of the data is received.

By adopting the continuous batch processing mechanism, a plurality of target feature sub-vectors can be processed in a pipeline manner in the plurality of processing units of the second processor, thereby improving the processing efficiency of the plurality of processing units and thus improving the overall processing speed of the system. Also, processing in a pipeline manner may conceal the data transmission time between different processing units and improve the utilization rate of the plurality of processing units in the second processor.

As shown in FIG. 2, taking the first processor being the CPU in the electronic device and the second processor being the GPU in the electronic device as an example, the implementation process of an embodiment of the data processing method provided by the present disclosure will be described in detail. As shown in FIG. 2, in the present embodiment, the method includes S201 to S211.

At S201, a user task is obtained and then S202 to S204 and S205 to S206 are executed in parallel.

After the electronic device obtains the user task, the CPU of the electronic device may load a large model corresponding to the user task, or call a large model that is already loaded.

At S202, the CPU generates a first feature vector and an index vector corresponding to the first feature, and then S203 is executed.

In the CPU domain, a tokenizer may be used to extract features from the text data in the user task to determine the data length corresponding to the text data. Also, the CPU may determine a fixed data length for the image data in the user task. Then, the CPU may generate the first feature vector based on the data length of the text data and the data length of the image data. The first feature vector may include a plurality of text feature bits for storing text data features and a plurality of image feature bits for storing image data features where the plurality of image data feature bits are filled with placeholders. Subsequently, the CPU may traverse the first feature vector to generate the index vector of the first feature vector.

At S203, the CPU sends the text data, the first feature vector and the index vector of the feature vector in the user task to the GPU and then S204 is executed.

At S204, the GPU performs feature extraction on the text data, and based on the index vector, updates the text feature bits in the first feature vector using the text data features to obtain a second feature vector. The S207 is executed.

At S205, the GPU reads the image data in the user task from the target memory and then S206 is executed.

At S206, the GPU performs feature extraction on the image data and then S207 is executed

After the GPU loads the image data into the GPU memory, the GPU may divide the image data into a plurality of pieces of sub-image-data, and use a plurality of computing units of the GPU to perform feature extraction on the plurality of pieces of sub-image-data respectively, to improve the feature extraction speed of the image data.

At S207, the GPU updates the image feature bits in the second feature vector based on the index vector and the image data features to obtain a third feature vector, and then S208 is executed.

In the process of updating the second feature vector, the second feature vector may be updated in parallel using the image data features corresponding to the plurality of sub-images based on the image data division operation in response to the feature extraction speed of a plurality of word pictures.

At S208, the GPU performs filling processing on the third feature vector to obtain a fused feature vector and then S209 is executed.

At S209, the GPU performs slicing processing on the fused feature vector to obtain a plurality of slicing vectors and then S210 is executed.

At S210, the GPU performs model reasoning on the plurality of slicing vectors using a plurality of processing units to obtain a model reasoning result, and then S211 is executed.

At S211, the GPU sends the model reasoning result to the CPU such that the CPU generates a processing result of the user task.

The CPU may generate the processing result of the user task according to the model reasoning result sent by the GPU, and display or output the processing result in voice.

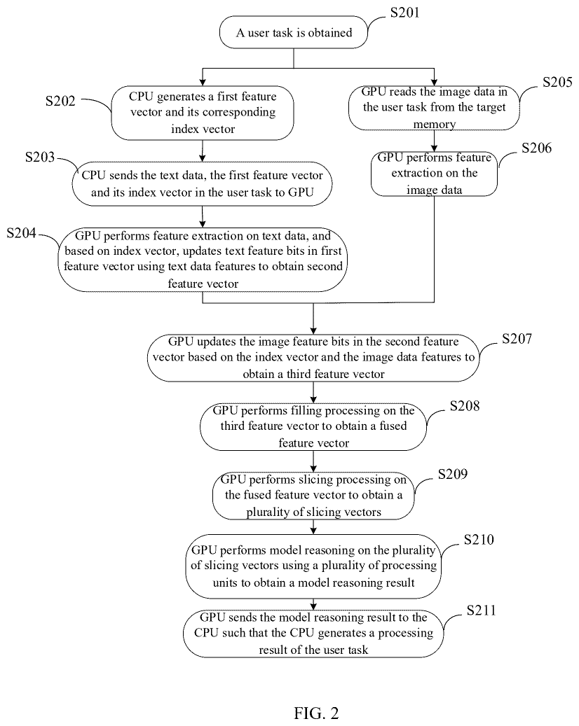

With references to FIG. 3, the timing of parallel processing on the GPU side in the embodiment shown in FIG. 2 will be explained below. In FIG. 3, the horizontal axis represents the number of cycles of data processing performed by the model, and the vertical axis represents the data processing tasks performed by the model, and only the processing timing of the first-layer neural network and the second-layer neural network is shown, but those skilled in the art should understand that the model may include the processing timing corresponding to the multi-layer neural network.

As shown in FIG. 3, in the t0 cycle, the model performs the text data processing task and the image data processing task in parallel. The model completes the feature extraction of the T0 part in the text data, and obtains 100 bits of feature data. The model also completes the feature extraction of the P0 part in the image data, and obtains 20 bits of feature data. At the same time, the first-layer neural network and the second-layer neural network are in an idle state;

In the t1 cycle, the model continues to perform the text data processing task and the image data processing task in parallel. The model completes the feature extraction of the T1 part in the text data, and obtains 110 bits of feature data. The model also completes the feature extraction of the P1 part in the image data, and obtains 30 bits of feature data. At the same time, the features corresponding to the T0 part of the text data and the features corresponding to the P0 part of the image data are input into the first-layer neural network for first-layer network processing to obtain 104 bits of feature data, while the second-layer neural network is still in an idle state.

In the t2 cycle, the model continues to perform text data processing and image data processing tasks in parallel. The model completes the feature extraction of the T2 part of the text data, and obtains 90 bits of feature data. The model also completes the feature extraction of the P2 part of the image data, and obtains 25 bits of feature data. At the same time, the features corresponding to the T1 part of the text data and the features corresponding to the P1 part of the image data are input into the first-layer neural network, and the first-layer network processing is performed to obtain 112 bits of feature data. The feature data obtained after the first-layer network processing is input into the second-layer neural network for second-layer network processing to obtain 104 bits of feature data.

By analogy, the model performs text data processing tasks, image data processing tasks, and reasoning tasks of each neural network layer in parallel in each model reasoning cycle.

In the present disclosure, there may be a pipeline relationship between the text data processing tasks, image data processing tasks, and each layer of network processing tasks implemented on the GPU side, and gradually increased pipeline calculations may be performed in sequence, and they may be executed in parallel after the pipeline is turned on. Therefore, the method provided by the present disclosure may have the advantages of high task processing efficiency and high utilization of each processing unit of the GPU, thereby making the overall reasoning speed of the system higher.

The present disclosure also provides a data processing apparatus. Various units in the data processing apparatus and modules included in each unit may be implemented by a processor in a computer device. Of course, they may also be implemented by a specific logic circuit. The processor can be a central processing unit (CPU), a microprocessor (MPU), a digital signal processor (DSP), or a field programmable gate array (FPGA), etc.

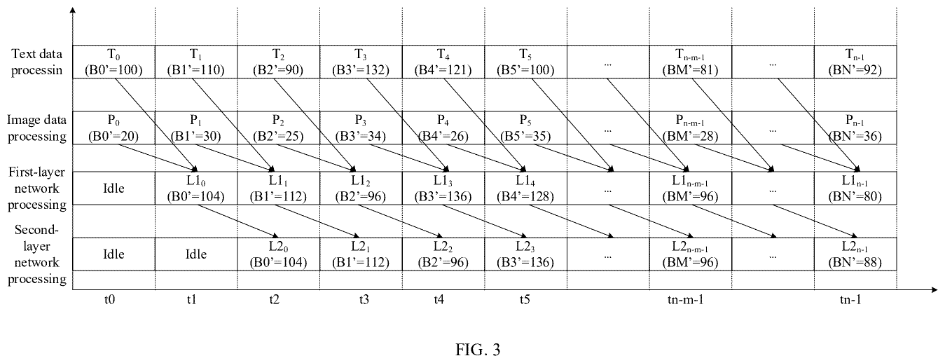

In one embodiment shown in FIG. 4, which is a schematic structural diagram of a data processing apparatus provided by the present disclosure, the data processing apparatus 400 includes: a first determination module 410, a second determination module 420, and a reasoning module 430.

The first determination module 410 may be configured to, in response to a target reasoning task, generate a first feature vector using a first processor. The first feature vector may include a plurality of first feature bits and a plurality of second feature bits. The plurality of first feature bits and the plurality of second feature bits may correspond to first data and second data in the target reasoning task respectively, where the first data and the second data are different types of data.

The second determination module 420 may be configured to: use a second processor to determine first data features corresponding to the first data and second data features corresponding to the second data; and use the first data features and the second data features to update the plurality of first feature bits and the plurality of second feature bits respectively to obtain a target feature vector.

The reasoning module 430 may be configured to perform model reasoning based on the target feature vector to obtain a target reasoning result corresponding to the target reasoning task.

In some embodiments, the second determination module 420 may be configured to use the second processor to perform a first processing and a second processing in parallel.

The first processing may include receiving the first feature vector and the first data from the first processor and determining the first data features corresponding to the first data.

The second processing may include reading the second data from a target memory and determining the second data features corresponding to the second data.

In some embodiments, the first determination module 410 may include:
a length determination module 411, configured to determine the first data length corresponding to the first data and the second data length corresponding to the second data respectively; and
a vector determination module 412, configured to generate the first feature vector based on the first data length and the second data length, such that the data length of the plurality of first feature bits and the data length of the plurality of second feature bits in the first feature vector correspond to the first data length and the second data length respectively.

In some embodiments, the length determination module 411 may be configured to:
determine the first data length based on the data volume of the first data; and
determine the second data length based on the type information of the second data.

In some embodiments, the data processing apparatus 400 may further include an index determination module 440.

The index determination module 440 may be configured to use the first processor to traverse the first feature vector to generate an index vector of the first feature vector.

The index vector may include a plurality of first index bits and a plurality of second index bits. The plurality of first index bits may have a mapping relationship with the plurality of first feature bits, and the plurality of second index bits may have a mapping relationship with the plurality of second feature bits.

In some embodiments, the index determination module 440 may be configured to fill each second feature bit with a placeholder.

Using the first processor to traverse the first feature vector to generate the index vector of the first feature vector may include:
traversing the first feature vector, determining a corresponding first index bit for each feature bit in the first feature vector that does not contain a placeholder, and determining a corresponding second index bit for each feature bit in the first feature vector that contains a placeholder; and
Generating the index vector based on the plurality of first index bits and the plurality of second index bits.

In some embodiments, the second determination module 420 may be configured to:
receive the index vector from the first processor;
determine the plurality of first feature bits and the plurality of second feature bits in the first feature vector based on the plurality of first index bits and the plurality of second index bits in the index vector; and
use the first data features and the second data features to update the plurality of first feature bits and the plurality of second feature bits to obtain the target feature vector.

In some embodiments, the second determination module 420 may be configured to:
use the first data features and the second data features to update the plurality of first feature bits and the plurality of second feature bits to obtain a third feature vector; and
perform filling processing on the third feature vector to obtain the target feature vector.

In some embodiments, the second processor may include a plurality of processor units; and
when being configured to perform model reasoning based on the target feature vector to obtain the target reasoning result corresponding to the target reasoning task, the interference module may be configured to:
based on a specified vector division rule, divide the target feature vector into at least one target feature sub-vector; and
use the plurality of processing units to process the at least one target feature sub-vector in parallel to obtain the target reasoning result.

The description of the above device embodiments is similar to the description of the above method embodiments, and may have similar beneficial effects as the method embodiments. In some embodiments, the functions or modules included in the device provided in the embodiments of the present disclosure may be used to execute the method described in the above method embodiments. For technical details not disclosed in the device embodiments of the present disclosure, references may be made to the description of the method embodiments of the present disclosure.

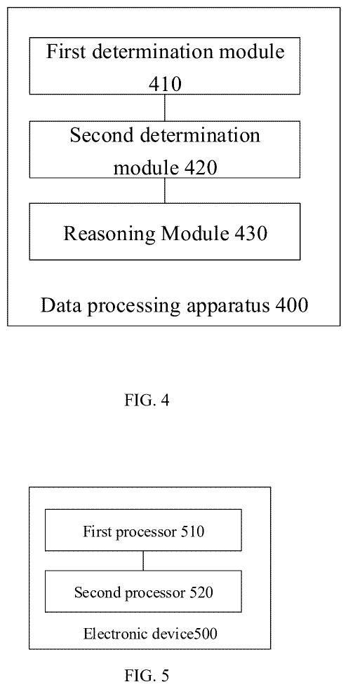

The present disclosure also provides an electronic device. As shown in FIG. 5, in one embodiment, the electronic device 500 includes a first processor 510 and a second processor 520.

The first processor 510 may be configured to generate a first feature vector in response to a target reasoning task. The first feature vector may include a plurality of first feature bits and a plurality of second feature bits. The plurality of first feature bits and the plurality of second feature bits may correspond to first data and second data in the target reasoning task respectively, where the first data and the second data are data of different types.

The second processor 520 may be configured to: determine first data features corresponding to the first data and second data features corresponding to the second data; use the first data features and the second data features to update the plurality of first feature bits and the plurality of second feature bits respectively to obtain a target feature vector; and perform model reasoning based on the target feature vector to obtain a target reasoning result corresponding to the target reasoning task.

In some embodiments, the second processor 520 may perform a first processing and a second processing in parallel.

The first processing may include receiving the first feature vector and the first data from the first processor 510 and determining the first data features corresponding to the first data.

The second processing may include reading the second data from a target memory and determining the second data features corresponding to the second data.

In some embodiments, the first processor 510 may be configured to:
determine the first data length corresponding to the first data and the second data length corresponding to the second data; and
generate the first feature vector based on the first data length and the second data length, such that the data length of the plurality of first feature bits and the data length of the plurality of second feature bits in the first feature vector correspond to the first data length and the second data length respectively.

In some embodiments, the first processor 510 may be configured to:
determine the first data length based on the data volume of the first data; and
determine the second data length based on the type information of the second data.

In some embodiments, the first processor 510 may traverse the first feature vector to generate an index vector of the first feature vector.

The index vector may include a plurality of first index bits and a plurality of second index bits. The plurality of first index bits may have a mapping relationship with the plurality of first feature bits, and the plurality of second index bits may have a mapping relationship with the plurality of second feature bits.

In some embodiments, the first processor 510 may be configured to:
fill each second feature bit with a placeholder.

Using the first processor to traverse the first feature vector to generate the index vector of the first feature vector may include:
traversing the first feature vector, determining a corresponding first index bit for each feature bit in the first feature vector that does not contain a placeholder, and determining a corresponding second index bit for each feature bit in the first feature vector that contains a placeholder; and
Generating the index vector based on the plurality of first index bits and the plurality of second index bits.

In some embodiments, the second processor 420 may be configured to:
receive the index vector from the first processor;
determine the plurality of first feature bits and the plurality of second feature bits in the first feature vector based on the plurality of first index bits and the plurality of second index bits in the index vector; and
use the first data features and the second data features to update the plurality of first feature bits and the plurality of second feature bits to obtain the target feature vector.

In some embodiments, the second processor 420 may be configured to:
use the first data features and the second data features to update the plurality of first feature bits and the plurality of second feature bits to obtain a third feature vector; and
perform filling processing on the third feature vector to obtain the target feature vector.

In some embodiments, the second processor 420 may be configured to:
use the first data features and the second data features to update the plurality of first feature bits and the plurality of second feature bits to obtain a third feature vector; and
perform filling processing on the third feature vector to obtain the target feature vector.

In some embodiments, the second processor 520 may include a plurality of processor units; and may be configured to:
based on a specified vector division rule, divide the target feature vector into at least one target feature sub-vector; and
use the plurality of processing units to process the at least one target feature sub-vector in parallel to obtain the target reasoning result.

The description of the above device embodiments is similar to the description of the above method embodiments, and may have similar beneficial effects as the method embodiments. In some embodiments, the functions or modules included in the device provided in the embodiments of the present disclosure may be used to execute the method described in the above method embodiments. For technical details not disclosed in the device embodiments of the present disclosure, references may be made to the description of the method embodiments of the present disclosure.

It should be noted that in the embodiments of the present disclosure, if the above-mentioned data processing method is implemented in the form of a software function module and sold or used as an independent product, it may also be stored in a computer-readable storage medium. Based on this understanding, the technical solution of the embodiments of the present disclosure may be essentially or partly reflected in the form of a software product that contributes to the relevant technology. The software product may be stored in a storage medium, including several instructions to enable a computer device (which can be a personal computer, server, or network device, etc.) to execute all or part of the methods described in each embodiment of the present disclosure. The aforementioned storage medium may include: a flash disk, a mobile hard disk, a read-only memory (ROM), a hard disk or an optical disk, etc., which can store program code. Therefore, the embodiments of the present disclosure are not limited to any specific hardware, software or firmware, or any combination of hardware, software and firmware.

The present disclosure also provides a computer-readable storage medium, on which a computer program is stored. When the computer program is executed by a processor, some or all of the steps in the above methods may be implemented. The computer-readable storage medium may be transient or non-transient.

The present disclosure also provides a computer program, including a computer-readable code. When the computer-readable code is executed in a computer device, a processor of the computer device may execute the computer-readable code to implement some or all of the processes in the above methods.

The present disclosure also provides a computer program product, which includes a non-transitory computer-readable storage medium storing a computer program. When the computer program is read and executed by a computer, some or all of the steps in the above methods may be implemented. The computer program product can be implemented in hardware, software or a combination thereof. In some embodiments, the computer program product may be specifically embodied as a computer storage medium. In some other embodiments, the computer program product may be specifically embodied as a software product, such as a software development kit (SDK), etc.

It should be pointed out here that the description of each embodiment above tends to emphasize the differences between the embodiments, and the same or similar aspects can be referenced to each other. The description of the above device, storage medium, computer program and computer program product embodiments is similar to the description of the above method embodiments, and has similar beneficial effects as the method embodiments. For technical details not disclosed in the embodiments of the device, storage medium, computer program and computer program product of the present disclosure, references may be made to the description of the method embodiments of the present disclosure for understanding.

It should be understood that “one embodiment” or “an embodiment” mentioned throughout the specification means that the specific features, structures or characteristics related to the embodiments are included in at least one embodiment of the present disclosure.

Therefore, “in one embodiment” or “in an embodiment” appearing throughout the specification does not necessarily refer to the same embodiment. In addition, these specific features, structures or characteristics can be combined in one or more embodiments in any suitable manner.

It should be understood that in various embodiments of the present disclosure, the size of the serial number of each step/process mentioned above does not mean the order of execution. The execution order of each step/process should be determined by its function and internal logic, and should not constitute any limitation on the implementation process of the embodiments of the present disclosure. The serial numbers of the embodiments of the present disclosure are only for description and do not represent the advantages or disadvantages of the embodiments.

It should be noted that in the present disclosure, the terms “include,” “comprise,” and any other variant thereof are intended to cover non-exclusive inclusion, such that a process, method, article or device including a series of elements includes not only those elements, but also includes other elements not explicitly listed, or also includes elements inherent to such process, method, article or device. In the absence of further restrictions, an element defined by the sentence “including a.” does not exclude the existence of other identical elements in the process, method, article or device including the element.

It should be understood that the disclosed devices and methods can be implemented in other ways. The device embodiments described above are only schematic. For example, the division of the units is only a logical function division. There may be other division methods in actual implementation, such as: a plurality of units or components can be combined, or can be integrated into another system, or some features can be ignored or not executed. In addition, the coupling, direct coupling, or communication connection between the components shown or discussed can be through some interfaces, and the indirect coupling or communication connection of the device or unit can be electrical, mechanical or other forms.

The units described above as separate components may or may not be physically separated, and the components shown as units may or may not be physical units. They may be located in one place or distributed on a plurality of network units. Some or all of the units may be selected according to actual needs to achieve the purpose of the scheme of the present disclosure.

In addition, all functional units in the embodiments of the present application can be integrated into one processing unit, or each unit can be separately used as a unit, or two or more units can be integrated into one unit; the above integrated unit can be implemented in the form of hardware or in the form of hardware plus software functional units.

Those skilled in the art can understand that all or part of the steps of implementing the above method embodiments can be completed by hardware related to program instructions, and the above program can be stored in a computer-readable storage medium. When the program is executed, the steps of the above method embodiments are executed; and the above storage medium includes: a mobile storage device, a read-only memory (ROM), a disk or an optical disk, and other media that can store program codes.

Alternatively, if the above integrated unit of the present application is implemented in the form of a software functional module and sold or used as an independent product, it can also be stored in a computer-readable storage medium. Based on this understanding, the technical solution of this application, or the part that contributes to the relevant technology, can be embodied in the form of a software product. The computer software product is stored in a storage medium, including several instructions to enable a computer device (which can be a personal computer, server, or network device, etc.) to execute all or part of the methods described in each embodiment of this application. The aforementioned storage medium includes: various media that can store program codes, such as mobile storage devices, ROMs, magnetic disks or optical disks.

The above describes in detail a plurality of embodiments of the present disclosure, but the present disclosure is not limited to these specific embodiments. Those skilled in the art can make various variations and modifications based on the concept of the present disclosure, and these variations and modifications should fall within the scope of the present disclosure.

What is claimed is:

1. A data processing method comprising:
generating, by a first processor, an initial feature vector in response to a target reasoning task, the initial feature vector including a plurality of first feature bits and a plurality of second feature bits corresponding to first data and second data, respectively, in the target reasoning task, and the first data and the second data being of different types;
determining, by a second processor, one or more first data features corresponding to the first data and one or more second data features corresponding to the second data;
updating, by the second processor, the plurality of first feature bits and the plurality of second feature bits using the one or more first data features and the one or more second data features, respectively, to obtain a target feature vector; and
performing model reasoning based on the target feature vector to obtain a target reasoning result corresponding to the target reasoning task.

2. The method according to claim 1, wherein:
determining, by the second processor, the one or more first data features and the one or more second data features includes performing first processing and second processing in parallel by the second processor;
the first processing includes receiving the initial feature vector and the first data from the first processor and determining the one or more first data features corresponding to the first data; and
the second processing includes reading the second data from a target memory and determining the one or more second data features corresponding to the second data.

3. The method according to claim 1, wherein generating the initial feature vector by the first processor in response to the target reasoning task includes:
determining a first data length corresponding to the first data and a second data length corresponding to the second data; and
generating the initial feature vector based on the first data length and the second data length, a data length of the plurality of first feature bits and a data length of the plurality of second feature bits in the initial feature vector corresponding to the first data length and the second data length, respectively.

4. The method according to claim 3, wherein determining the first data length and the second data length includes:
determining the first data length based on a data amount of the first data; and
determining the second data length based on type information of the second data.

5. The method according to claim 1, further comprising:
traversing, by the first processor, the initial feature vector to generate an index vector of the initial feature vector;
wherein the index vector includes:
a plurality of first index bits having a mapping relationship with the plurality of first feature bits, and
a plurality of second index bits having a mapping relationship with the plurality of second feature bits.

6. The method according to claim 5, further comprising:
filling each of the plurality of second feature bits with a placeholder;
wherein traversing, by the first processor, the initial feature vector to generate the index vector includes:
traversing the initial feature vector to determine one of the plurality of first index bits for each of the plurality of first feature bits in the initial feature vector that does not contain the placeholder and determine one of the plurality of second index bits for each of the plurality of second feature bits in the initial feature vector that contains the placeholder; and
generating the index vector based on the plurality of first index bits and the plurality of second index bits.

7. The method according to claim 5, wherein:
determining, by the second processor, the one or more first data features and the one or more second data features includes performing first processing and second processing in parallel by the second processor;
the first processing includes receiving the initial feature vector and the first data from the first processor, determining the one or more first data features corresponding to the first data, and receiving the index vector from the first processor;
the second processing includes reading the second data from a target memory and determining the one or more second data features corresponding to the second data; and
updating the plurality of first feature bits and the plurality of second feature bits includes:
determining the plurality of first feature bits and the plurality of second feature bits in the initial feature vector based on the plurality of first index bits and the plurality of second index bits in the index vector, respectively; and
updating the plurality of first feature bits and the plurality of second feature bits using the one or more first data features and the one or more second data features, respectively, to obtain the target feature vector.

8. The method according to claim 1, wherein updating the plurality of first feature bits and the plurality of second feature bits using the one or more first data features and the one or more second data features, respectively, to obtain the target feature vector includes:
updating the plurality of first feature bits and the plurality of second feature bits using the one or more first data features and the one or more second data features, respectively, to obtain an intermediate feature vector; and
performing padding processing on the intermediate feature vector to obtain the target feature vector.

9. The method according to claim 1, wherein:
the second processor includes a plurality of processor units; and
performing the model reasoning based on the target feature vector to obtain the target reasoning result corresponding to the target reasoning task includes:
dividing the target feature vector into at least one target feature sub-vector based on a vector division rule; and
processing the at least one target feature sub-vector in parallel by the plurality of processing units to obtain the target reasoning result.

10. An electronic device comprising:
a first processor configured to generate an initial feature vector in response to a target reasoning task, the initial feature vector including a plurality of first feature bits and a plurality of second feature bits corresponding to first data and second data, respectively, in the target reasoning task, and the first data and the second data being of different types; and
a second processor configured to:
determine one or more first data features corresponding to the first data and one or more second data features corresponding to the second data;
update the plurality of first feature bits and the plurality of second feature bits using the one or more first data features and the one or more second data features, respectively, to obtain a target feature vector; and
perform model reasoning based on the target feature vector to obtain a target reasoning result corresponding to the target reasoning task.

11. The electronic device according to claim 10, wherein:
the second processor is further configured to, when determining the one or more first data features and the one or more second data features, perform first processing and second processing in parallel;
the first processing includes receiving the initial feature vector and the first data from the first processor and determining the one or more first data features corresponding to the first data; and
the second processing includes reading the second data from a target memory and determining the one or more second data features corresponding to the second data.

12. The electronic device according to claim 10, wherein the first processor is further configured to, when generating the initial feature vector in response to the target reasoning task:
determine a first data length corresponding to the first data and a second data length corresponding to the second data; and
generate the initial feature vector based on the first data length and the second data length, a data length of the plurality of first feature bits and a data length of the plurality of second feature bits in the initial feature vector corresponding to the first data length and the second data length, respectively.

13. The electronic device according to claim 12, wherein the first processor is further configured to, when determining the first data length and the second data length:
determine the first data length based on a data amount of the first data; and
determine the second data length based on type information of the second data.

14. The electronic device according to claim 10, wherein:
the first processor is further configured to traverse the initial feature vector to generate an index vector of the initial feature vector; and
the index vector includes:
a plurality of first index bits having a mapping relationship with the plurality of first feature bits, and
a plurality of second index bits having a mapping relationship with the plurality of second feature bits.

15. The electronic device according to claim 14, wherein the first processor is further configured to:
fill each of the plurality of second feature bits with a placeholder; and
when traversing the initial feature vector to generate the index vector:
traverse the initial feature vector to determine one of the plurality of first index
bits for each of the plurality of first feature bits in the initial feature vector that does not contain the placeholder and determine one of the plurality of second index bits for each of the plurality of second feature bits in the initial feature vector that contains the placeholder; and
generate the index vector based on the plurality of first index bits and the plurality of second index bits.

16. The electronic device according to claim 14, wherein:
the second processor is further configured to, when determining the one or more first data features and the one or more second data features, perform first processing and second processing in parallel by the second processor;
the first processing includes receiving the initial feature vector and the first data from the first processor, determining the one or more first data features corresponding to the first data, and receiving the index vector from the first processor;
the second processing includes reading the second data from a target memory and determining the one or more second data features corresponding to the second data; and
the second processor is further configured to, when updating the plurality of first feature bits and the plurality of second feature bits:
determine the plurality of first feature bits and the plurality of second feature bits in the initial feature vector based on the plurality of first index bits and the plurality of second index bits in the index vector, respectively; and
update the plurality of first feature bits and the plurality of second feature bits using the one or more first data features and the one or more second data features, respectively, to obtain the target feature vector.

17. The electronic device according to claim 10, wherein the second processor is further configured to, when updating the plurality of first feature bits and the plurality of second feature bits using the one or more first data features and the one or more second data features, respectively, to obtain the target feature vector includes:
update the plurality of first feature bits and the plurality of second feature bits using the one or more first data features and the one or more second data features, respectively, to obtain an intermediate feature vector; and
perform padding processing on the intermediate feature vector to obtain the target feature vector.

18. The electronic device according to claim 10, wherein:
the second processor includes a plurality of processor units; and
the second processor is further configured to, when performing the model reasoning based on the target feature vector to obtain the target reasoning result corresponding to the target reasoning task:
divide the target feature vector into at least one target feature sub-vector based on a vector division rule; and
process the at least one target feature sub-vector in parallel using the plurality of processing units to obtain the target reasoning result.

19. One or more non-transitory computer-readable storage mediums storing:
first instructions that, when executed by a first processor, cause the first processor to generate an initial feature vector in response to a target reasoning task, the initial feature vector including a plurality of first feature bits and a plurality of second feature bits corresponding to first data and second data, respectively, in the target reasoning task, and the first data and the second data being of different types; and
second instructions that, when executed by a second processor, cause the second processor to:
determine one or more first data features corresponding to the first data and one or more second data features corresponding to the second data;
update the plurality of first feature bits and the plurality of second feature bits using the one or more first data features and the one or more second data features, respectively, to obtain a target feature vector; and
perform model reasoning based on the target feature vector to obtain a target reasoning result corresponding to the target reasoning task.

20. The one or more storage mediums according to claim 19, wherein:
the first instructions, when executed by the second processor, further cause the second processor to, when determining the one or more first data features and the one or more second data features, perform first processing and second processing in parallel;
the first processing includes receiving the initial feature vector and the first data from the first processor and determining the one or more first data features corresponding to the first data; and
the second processing includes reading the second data from a target memory and determining the one or more second data features corresponding to the second data.
